(19) United States
(12) Patent Application Publication
(10) Pub. No.: US 2005/0039530 A1
(43) Pub. Date: Feb. 24, 2005

(54) Micromechanical sensor having a self-test function and optimization method

(76) Inventors: Ralf Schellin, Munchen (DE); Michael Fehrenbach, Mittelstadt (DE); Michael Klink, Reutlingen (DE)

Correspondence Address: KENYON & KENYON, ONE BROADWAY, NEW YORK, NY, 10004, US

(21) Appl. No.: 10/491,676

(22) PCT Filed: Sep. 4, 2002
(86) PCT No.: PCT/DE02/03252

(30) Foreign Application Priority Data
Oct. 4, 2001 (DE) 101 48 858.0

(51) Int. Cl. G01P 15/125

(52) U.S. Cl. 73/514.32; 29/595

(57) ABSTRACT

A micromechanical sensor is described having a substrate with a structured layer on it, a seismic mass that is movable relative to the structured layer under the effect of a spring force, at least one measuring capacitor electrode array for registering a displacement of the seismic mass in a direction of measurement, and at least one drive capacitor electrode array for deflecting the seismic mass in a self-test direction, the direction of measurement being oriented perpendicular to the self-test direction. A corresponding optimization method is also described.

### FIELD OF THE INVENTION

The present invention relates to a micromechanical sensor having a self-test function and a corresponding method of optimization.

### BACKGROUND INFORMATION

The performance of a self-test on a micromechanical sensor includes testing the functionality of the sensor without the sensor having to be subjected to the physical measuring capacitor variable (e.g. acceleration, rotational speed, etc.) which the sensor is actually configured to detect.

Conventional micromechanical sensors may include a substrate, a seismic mass that is movable against a Si structured layer under the force of a spring, which undergoes a displacement proportional to the magnitude of the measuring capacitor variable under the influence of the physical measuring capacitor variable to be measured, and a measuring capacitor electrode array for measuring this displacement of the seismic mass.

To perform a self-test on such a sensor, a drive capacitor electrode array may be used which is oriented parallel to the measuring capacitor electrode array, and with whose help the seismic mass may be driven to move even without the influence of the measuring capacitor variable.

In this case, the drive capacitor electrode array is thus different from the measuring capacitor electrode array, and is used to detect a stationary displacement of the seismic mass caused by a static voltage applied to the drive capacitor electrodes.

A single set of electrodes in time division multiplex may be also used as drive and measuring capacitor electrodes, where for example at a first point of time a displacement of the seismic mass is triggered by a driving voltage applied to the electrodes, and at a later time a resulting motion of the seismic mass is measured using the same electrodes.

With such a self-test, a rough estimate of the functionality of the sensor may be made, because with both design principles named above the tolerances of the self-test responses may be more than ±15% due to manufacturing tolerances in etching the micromechanical structures.

The said production tolerances during etching, which may be performed as a dry etching process, may arise due to differing process temperatures, process gas compositions or process gas flow rates. This dry etching process may be employed to structure the seismic mass and the electrode finger arrays, since it may enable nearly vertical flanks to be achieved. With etching processes, some lateral under-etching of the structures may occur under the etching stop mask.

FIG. 3 shows as an example a sectional view through two opposing electrode fingers to illustrate the etching tolerances.

In FIG. 3, MA designates an etching stop mask, E1 and E2 are first and second electrode fingers made of polysilicon, d₀ is a design dimension, d a manufacturing dimension, and δ an under-etching.

As may be seen from FIG. 3, with approximately symmetrical etching the space between the opposing electrode fingers E1, E2 is increased due to the under-etching by the distance 2δ, this change in spacing also being known as edge loss kᵥ. The capacitor plate gap of the electrode fingers is therefore:
d=d₀+kᵥ

Similarly, the width of an electrode finger is reduced by the edge loss kᵥ.

This edge loss has a high tolerance of around ±70%, and hence may be the main factor influencing the sensitivity of the sensor and the tolerances of the self-test responses.

Although these micromechanical sensor elements may be manufactured so they have nearly tolerance-free sensitivity, i.e. the residual tolerance of the sensitivity is around 1-2% with edge loss tolerances of ±70%, it is believed that the tolerances of the test signal response may be brought to an acceptable level. In particular, these tolerance may be on an order of magnitude of more than ±15%.

Reasons for these large tolerances of the test signal response may include the quadratic dependence of the electrostatic force on the gap interval between the electrode fingers and the resulting cubic dependence of the test signal response on the edge loss, as well as the feature that the geometry parameters in the test signal compensation differ from those of the sensitivity compensation.

To date, it is believed that achieving the most exact test signal response possible, through which it is possible for example to detect drifting of the sensor sensitivity, has therefore required a cost-intensive, technically complex and error-prone comparison in the ASIC, which evaluates the motion of the seismic mass and hence the change in capacitance of the sensor element.

### SUMMARY OF THE INVENTION

A micromechanical sensor having a self-test function according to an exemplary embodiment of the present invention may reduce the tolerances of the test signal response while at the same time preserve the sensitivity compensation, so that a more exact detection of drifting of sensor parameters may be provided, in particular of its sensitivity, without an additional compensation being required.

In this regard, the electrodes required to generate the self-test response may be positioned so that the dependence of the force on the square of the edge loss is reduced. To that end, the drive electrodes for producing the self-test response are separate from the measuring electrode array and positioned perpendicular to the latter, resulting in only a linear dependence of the electrostatic force on the edge loss and thus a corresponding reduction in the tolerance of the self-test response. In particular, the dependence of the self-test response on the edge loss with the proposed sensor is now only quadratic. With the sensor according to an exemplary embodiment of the present invention, the tolerance of the self-test response may be only ±5%.

Furthermore, by optimizing the equivalent acceleration, namely the quotient of the self-test response to sensitivity, the value of the tolerance of the self-test response may even be reduced to ±2%, so that the test signal compensation may be completely dispensed with.

According to an exemplary embodiment, the measuring capacitor electrode array is positioned so that a displacement of the seismic mass in the direction of measurement causes a change in the spacing of the measuring capacitor electrodes.

According to another exemplary embodiment, the drive capacitor electrode array is arranged so that a deflection of the seismic mass in the self-test direction causes a change in the spacing of the measuring capacitor electrodes and a parallel shift of the drive capacitor electrode array.

According to another exemplary embodiment, the drive capacitor electrode array includes two outer electrodes and an inner electrode in a gap between the outer electrodes, with either the outer electrodes being fixed and the inner electrode movable, or the outer electrodes being movable and the inner electrode fixed. This exemplary embodiment has the feature that it may be repeated many times.

According to another exemplary embodiment, the tolerance of the self-test response of the sensor in regard to a process-dependent edge loss may be optimized when forming the measuring capacitor electrodes.

### BRIEF DESCRIPTION OF THE DRAWINGS

FIG. 1 shows a top view of a micromechanical sensor according to a first exemplary embodiment of the present invention.

FIG. 2 shows a sectional view through the sensor of FIG. 1.

FIG. 3 shows an illustration to explain the edge loss as a manufacturing parameter.

FIG. 4 shows a schematic illustration of conventional generation of the self-test response.

FIG. 5 shows a schematic illustration of the generation of the self-test response according to an exemplary embodiment of the present invention.

### DETAILED DESCRIPTION

In the figures, same reference symbols designate the same or functionally equivalent elements.

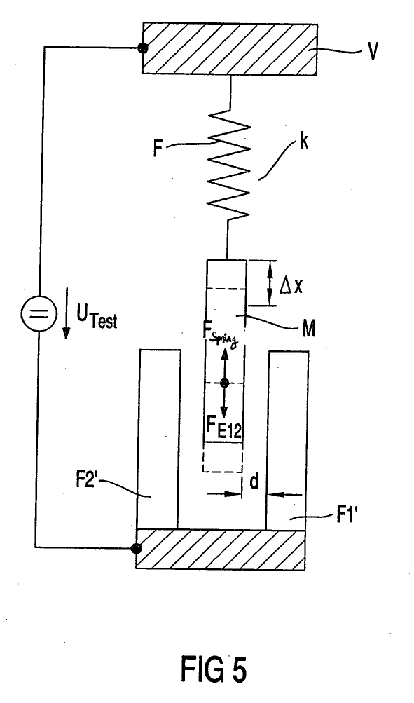

FIG. 4 initially shows a schematic illustration of a conventional generation of the self-test response.

In FIG. 4, V designates an anchor which is connected through a spring F having spring constant k to a seismic mass M. F1 is a fixed electrode which has an overlap ÜE with the seismic mass. Uₜₑₛₜ designates an applied static self-test voltage. It should be remarked in that connection that Uₜₑₛₜ may also be dynamic.

To achieve a deflection of seismic mass M without an external acceleration acting on seismic mass M, an electrostatic force F_{El1} is generated with the help of the test voltage Uₜₑₛₜ. For this purpose the mechanism of bringing two capacitor plates close together by applying a voltage has been used heretofore, producing an equivalent acceleration through the electrostatic force. This may be expressed by the following interrelationship:
F_{El1}=(∈₀·∈ᵣ·A·Uₜₑₛₜ²)/(2·d²)
where ∈₀ is the dielectric constant of vacuum, ∈ᵣ the relative dielectric constant, A the capacitor area, and d the distance between the capacitor electrodes.

If the plates are subjected to a force according to the above formula, a force equilibrium with spring force F_{spring} may be assumed; that is,
F_{spring}=F_{El1}

If the change in the spacing of the plates is designated as Δd, then
k·Δd=(∈₀·∈ᵣ·A·Uₜₑₛₜ²)/2·(d−Δd)²

Furthermore, the sensitivity E of such a sensor is E=(Δd/d)·(U_{ref}/a), where U_{ref} is a reference voltage and a is the applied acceleration.

If we solve the above equation for Δd, substitute this into the latter equation and continue to allow for the edge loss kᵥ, it is possible to determine the numerical value of output voltage U (self-test response), caused by the applied test voltage, downstream from the C/U converter.

For the sake of simplicity, the following approximation is used:
U(kᵥ)=K2/((d₀+kᵥ)³*(b_{f}−kᵥ)³)

The constant K2 here is not a function of the edge loss, and b_{f} designates the spring width or electrode width.

The quadratic dependence of the electrostatic force on the plate spacing and the resulting cubic dependence of the self-test response thus result for the usual self-test function in the aforementioned large tolerance (over ±15%) of the output voltage.

FIG. 5 shows a schematic illustration of the generation of the self-test response according to exemplary embodiment of the present invention.

According to FIG. 5, a parallel shifting of two capacitor plates is used to generate a self-test response. Here movable seismic mass m is moved by a distance Δx with respect to the pair of fixed capacitor plates F1′, F2′ by applying test voltage Uₜₑₛₜ.

In analogy to the above observations in connection with FIG. 4, the following equilibrium of forces appears after a shift by Δx:
F_{spring}=F_{El2}
or
K·Δx=(∈₀·∈ᵣ·h·U²ₜₑₛₜ)/(2·d)

Here a shift Δx of the self-test electrodes corresponds to a shift Δd of the measuring electrodes, i.e. Δd=Δx. If the last equation is solved for Δx. the result for the output voltage U′ (self-test response) is
U′=K3·1/(d_{0,1}+kᵥ)·(d_{0,2}+kᵥ)·(b_{f}−kᵥ)³

Here d_{0,1} is the gap during the detection and d_{0,2} the gap during the self-test. These may be configured to be different or the same. The constant K3 is not a function of the edge loss kᵥ. It is evident from this equation that, contrary to the conventional principle, the self-test response now exhibits only a quadratic dependence on the edge loss. A reduction of the tolerance of the self-test response to 5% corresponds to an improvement over the conventional self-test principle by a factor of three.

To further minimize the tolerance of the self-test response, the above equation may be differentiated by the edge loss kᵥ and set to zero. That may make it possible to determine the numerical value of that edge loss kᵥ* at which the smallest tolerance of the self-test response appears for given design values. However, this determined optimal value of the edge loss kᵥ* differs from the optimized edge loss value kᵥ* for the sensitivity compensation.

In order to adjust the sensitivity to the tolerance of the self-test response, it may be possible instead to derive the equivalent acceleration by edge loss kᵥ.

The equivalent acceleration is represented by:
a_{equiv}=U′(kᵥ)/E(kᵥ)=K4·1/(d_{0,2}+kᵥ)·(bₘkᵥ)

Constant K4 is also not a function of the edge loss.

The following equivalent conditions result for the desired minima:
bₘ=d_{0,2}+2kᵥ and d_{0,2}=bₘ−2kᵥ and kᵥ=(bₘ−d_{0,2})/2

If these conditions and the condition dE/dkᵥ=0 are satisfied, a tolerance of the self-test response of only ±2% may be achieved. At this tolerance level, the compensation that was formerly conventional may be eliminated in any case.

The optimization algorithm set forth above may be applied in principle to all sensors with differential sensing capacities, such as acceleration sensors, acceleration switches, rotational speed sensors, etc.

Further considerations show that with the exemplary method for optimizing the self-test response and the sensitivity with certain designs, a minimum of the sensitivity tolerance coincides with a minimum of the self-test response tolerance.

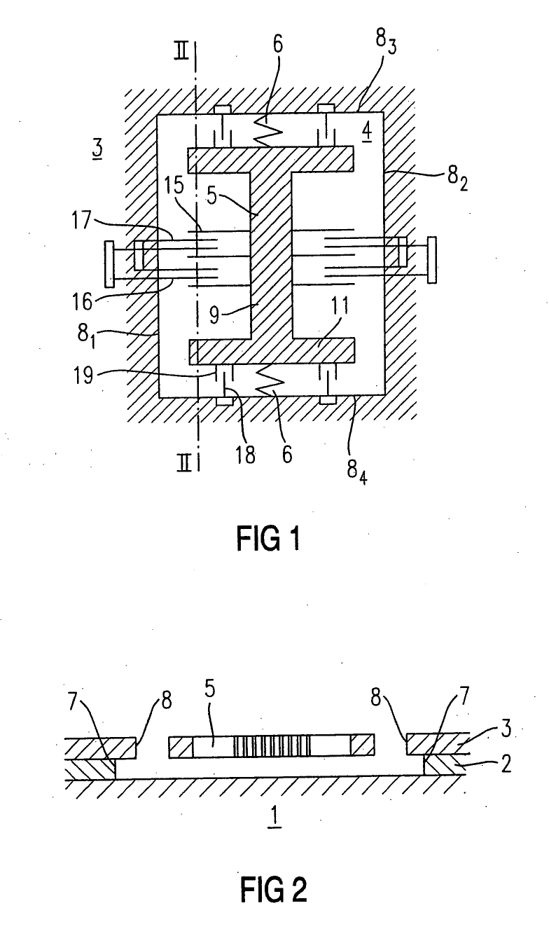

FIGS. 1 and 2 show a micromechanical sensor according to a first exemplary embodiment of the present invention in a top view and in a sectional view along line II-II of FIG. 1, in which the generation of the self-test response according to an exemplary embodiment of the present invention as described above is executable.

The sensor is made up of a silicon substrate 1, on which, separated by a SiO₂ sacrificial layer, there is a silicon structured layer 3. A window 4 is etched into structured layer 3, with a seismic mass 5 and elastic connecting webs 6 having been left intact in the middle of window 4 between seismic mass 5 and the surrounding structured layer 3. This etching step, whose purpose is to structure silicon structured layer 3, is responsible for the aforementioned edge loss kᵥ. Using an additional step of etching sacrificial layer 2 through window 4, seismic mass 5 is separated from the substrate and made movable.

Seismic mass 5 may have essentially the shape of a letter H, with central bar 9 of the H carrying a plurality of movable electrodes 15 and the two side bars 11 having essentially the function of contributing to the weight of seismic mass 5 and thus to its sensitivity. Seismic mass 5 may be made up of individual narrow bars, because the wider the elements, the longer the time needed to eliminate the sacrificial layer 2 under seismic mass 5, and the edge loss, which by itself may be undesired, increases as the etching time increases.

Movable measuring capacitor electrodes 15 extend out in two directions from central bar 9 and operate together with two sets of fixed measuring capacitor electrodes 16 and 17 which project from two opposing edges 8₁, 8₂ of structured layer 3 into square window 4.

Based on the capacitance changes in phase opposition of the two measuring capacitor electrode arrays on the two sides of central bar 9, it is possible to detect and measure a deflection of seismic mass 5 under the influence of an external force that is to be detected.

From another pair of opposing edges 8₃, 8₄, fixed self-test drive capacitor electrodes 8 extend into window 4 and work together with movable drive capacitor electrodes 19 formed on side bars 11 of seismic mass 5. The surfaces of drive capacitor electrodes 18, 19 run perpendicular to those of measuring capacitor electrodes 15, 16, 17.

FIG. 1 shows a single fixed drive capacitor electrode 18, which meshes with two movable drive capacitor electrodes 19 with a gap width of d on both sides. Alternatively, a movable drive capacitor electrode may mesh with two fixed ones, or the number of drive capacitor electrodes may be larger.

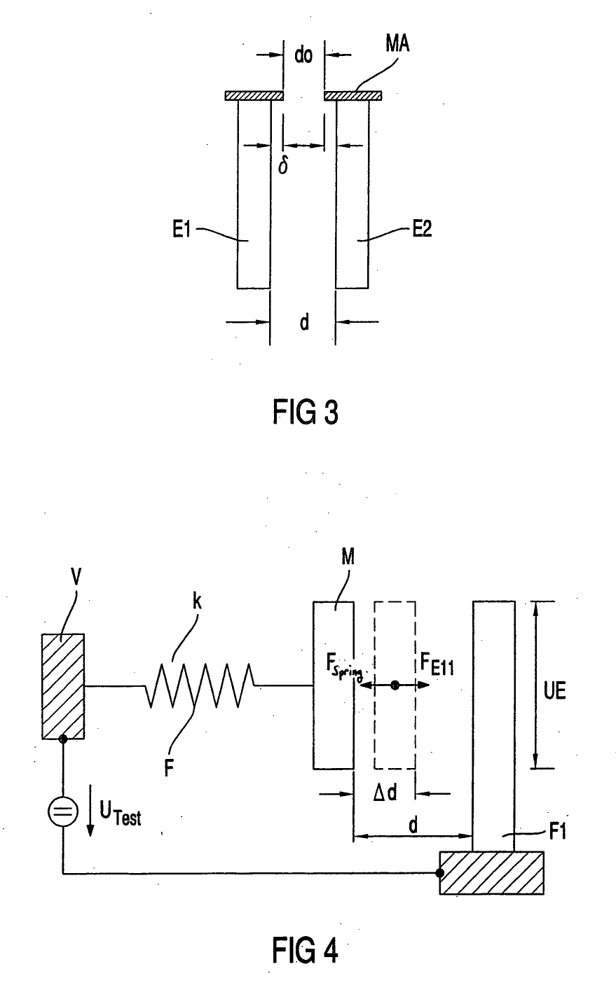

By applying a drive voltage U in phased opposition to drive capacitor electrodes 18, a displacement of seismic mass 5 may be brought about that is parallel to line II-II in FIG. 3. This displacement causes a change in the spacing of the plates of measuring capacitor electrodes 15, 16, 17. The detection and evaluation of this change in the self-test function according to an exemplary embodiment of the present invention was already described in general earlier.

1-6. (canceled).

7. A micromechanical sensor, comprising:
a substrate;
a structured layer arranged on the substrate;
a seismic mass configured to be movable relative to the structured layer by application of a spring force;
at least one measuring capacitor electrode array to detect a displacement of the seismic mass in a direction of measurement; and
at least one drive capacitor electrode array to deflect the seismic mass in a self-test direction;
wherein the direction of measurement is oriented perpendicular to the self-test direction.

8. The micromechanical sensor according to claim 7, wherein the at least one measuring capacitor electrode array is arranged so that the displacement of the seismic mass in the direction of measurement causes a change in a spacing of measuring capacitor electrodes within the measuring capacitor electrode array.

9. The micromechanical sensor according to claim 7, wherein the at least one drive capacitor electrode array is arranged so that a deflection of the seismic mass in the self-test direction causes a change in a spacing of measuring capacitor electrodes within the measuring capacitor electrode array.

10. The micromechanical sensor according to claim 7, wherein the at least one drive capacitor electrode array includes two outer electrodes and one inner electrode in an intermediate space between the outer electrodes, and wherein at least one of:
the outer electrodes are fixed and the inner electrode are movable; and
the outer electrodes are movable and the inner electrode are fixed.

11. A method of optimizing a configuration of a micromechanical sensor having a substrate, a structured layer arranged on the substrate, a seismic mass configured to be movable relative to the structured layer by application of a spring force, at least one measuring capacitor electrode array to detect a displacement of the seismic mass in a direction of measurement, and at least one drive capacitor electrode array to deflect the seismic mass in a self-test direction, the direction of measurement being oriented perpendicular to the self-test direction, the method comprising:
optimizing a tolerance of a self-test response in regard to a process-dependent edge loss when forming the at least one measuring capacitor electrode array.

12. The method according to claim 11, wherein a tolerance of a sensitivity in regard to the process-dependent edge loss is optimized when forming the at least one measuring capacitor electrode array.
